(19) United States
(12) Patent Application Publication
(10) Pub. No.: US 2010/0293042 A1
(43) Pub. Date: Nov. 18, 2010

(54) SYSTEM AND METHOD FOR VARIABLE DISCOUNT SALES DEVICE

(75) Inventors: Timothy G. McManus, Philadelphia, PA (US); Christopher McManus, Mendham, NJ (US)

Correspondence Address: FOX ROTHSCHILD LLP;PRINCETON PIKE CORPORATE CENTER, 997 LENOX DRIVE, BLDG. #3, LAWRENCEVILLE, NJ, 08648, US

(73) Assignee: Open Matrix LLC, Mendham, NJ (US)

(21) Appl. No.: 12/863,516

(22) PCT Filed: Jan. 21, 2009
(86) PCT No.: PCT/US2009/031558

§ 371 Date: Jul. 19, 2010

Related U.S. Application Data
(60) Provisional application No. 61/021,926, filed on Jan. 18, 2008.

(51) Int. Cl. G06Q 30/00

(52) U.S. Cl. 705/14.1

(57) ABSTRACT

A variable discount sales device that acts as an automated agent or broker by efficiently, and automatically, aggregating a sizable number of individual buyers into a single unit. The device allows variable discounts to be offered to the buyers, including a possibility of getting the item for free. In this way, buyers may be highly incentivized, while manufacturers may sell directly to end users. The discounts are possible because of the economies of scale that may result from the aggregation of the buyers, even though they may be individuals or small companies. Other savings may be made possible by eliminating middlemen and reducing shipping cost.

### CROSS REFERENCE TO APPLICATIONS

This application is related to, and claims priority from, U.S. Provisional Patent application No. 61/021,926 filed on Jan. 18, 2008, by T. McManus et al, titled “Online Open Market”, the contents of which are hereby incorporated by reference.

### TECHNICAL FIELD

The present invention relates to program storage devices containing computer readable program code for causing a computer to respond to sales offers by associating variable discounts with the sale offer, and to the storing of the variable discount, and to the subsequent use of the stored discount to complete the transaction.

### BACKGROUND ART

In the field of retail selling, large stores are typically able to offer better prices to the consumer than smaller stores are, primarily because of the structure of retail distribution channels. One advantage that the large stores have is their ability to order large numbers of product from a manufacturer. This typically allows the manufacturer to achieve significant economies of scale and so be able to offer the product to the large store at a lower unit price. Small stores typical order product in lower volume, or may be forced to deal with middlemen, either way resulting in significantly higher unit prices. These higher unit prices must either be passed on to the customer or result in reduced profit for the small store.

A device that could level the playing field between large and small stores in terms of the unit cost of they pay for product, would allow more traditional “mom and pop” stores to compete with the large supermarket chains. Such a device would be considered highly desirable by many small stores and individuals. In addition, may urban planners would find such a device highly desirable as it may allow more traditional towns to compete effectively with malls, thereby possibly reducing urban sprawl.

### SUMMARY OF INVENTION

The present invention is a variable discount sales device that, in a preferred embodiment, acts as an automated agent or broker that may efficiently, and automatically, aggregate a sizable number of individual buyers into a single unit. The present invention allows variable discounts to be offered to the buyers, including the possibility of getting the item for free. In this way, the present invention may incentivize buyers to cooperate and may allow manufacturers to sell directly to end users. The discounts may be possible because of economies of scale enabled by the aggregation of a number of individuals or small companies. Other savings made possible by the present invention may include eliminating middlemen and reducing shipping costs.

### TECHNICAL PROBLEM

The technical problems addressed by the present invention include the problem of storing data concerning the availability of certain goods and/or services, and data concerning willing buyers for those goods and services, on a computer usable medium. In particular, one of the technical problems include how to store data so that it may be used in a way that motivates groups of independent buyers to jointly complete, within a reasonable time-scale, a purchase of a quantity of goods or services sufficient to provide significant economies of scale for a manufacturer or wholesaler of those goods or services.

### SOLUTION TO PROBLEM

The present invention solves the problem by providing a computer program storage device containing computer readable program code crafted to cause a computer to present data concerning to buyers, and then to randomly, or pseudo-randomly, assign one of a number of price discounts to that willing buyer. The computer readable program code may further cause the computer to store that decision until enough willing buyers have been found for a predetermined total quantity of goods or services to be the subject of an offer to buy. When such a point is reached, the program code may then cause the computer to complete the sale of all the goods and services, including causing notifications to be sent to all willing buyers that may include the price discount assigned to them.

### ADVANTAGEOUS EFFECTS OF INVENTION

Advantages of the invention include, but are not limited to, facilitating computers, via suitable computer readable code, to enable more efficient and effective sale and distribution of goods and services.

These and other features of the invention will be more fully understood by references to the following drawings.

### BRIEF DESCRIPTION OF DRAWINGS

FIG. 1 shows a schematic representation of one embodiment of the present invention.

FIG. 2 shows a flow chart having steps representative of one embodiment of the present invention.

FIG. 3 shows a schematic of a screen for displaying information to a potential buyer in a representative embodiment of the present invention.

FIG. 4 shows a schematic matrix displaying a state of an open matrix variable discount sales device.

FIG. 5 shows a schematic matrix displaying a state of a hidden matrix variable discount sales device.

FIG. 6 shows a schematic matrix displaying a state of a completely hidden matrix variable discount sales device.

FIG. 7A shows a schematic matrix displaying an 80% open matrix variable discount sales device at a first stage of sale.

FIG. 7B shows a schematic matrix displaying an 80% open matrix variable discount sales device at a second stage of sale.

FIG. 8 shows a schematic matrix displaying a state of a second chance matrix variable discount sales device.

FIG. 9 shows a schematic matrix displaying a state of a split top matrix variable discount sales device.

### DESCRIPTION OF EMBODIMENTS

Embodiments of the present invention will now be described in detail by reference to the accompanying drawings in which, as far as possible, like elements are designated by like numbers.

Although every reasonable attempt is made in the accompanying drawings to represent the various elements of the embodiments in relative scale, it is not always possible to do so with the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

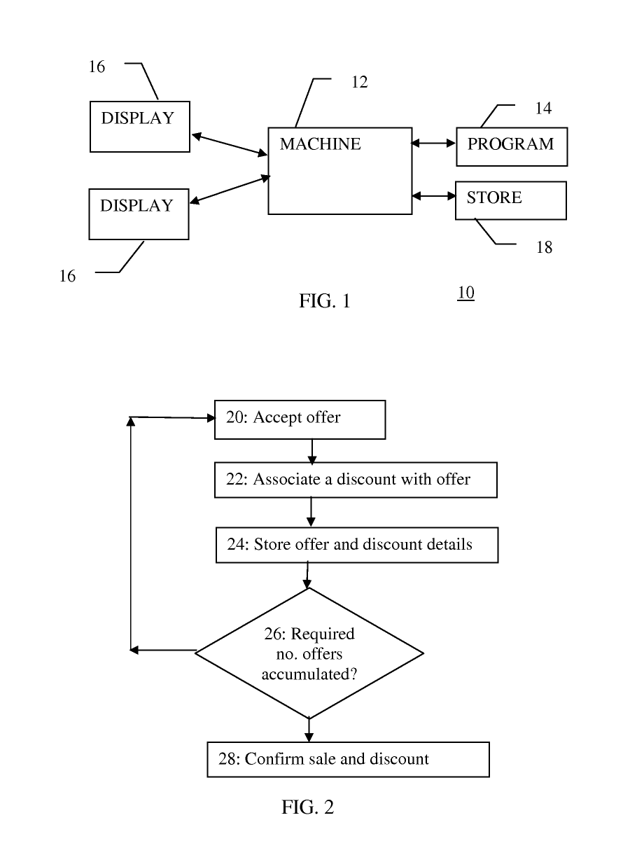

FIG. 1 shows a schematic representation of one embodiment of a variable discount sales device, 10, of the present invention. The variable discount sales device, 10, may include a machine capable of executing instructions, 12, a program storage device, 14, a data storage module, 18, and, optionally, one or more display devices, 16.

The machine capable of executing instructions, 12, may for instance be, but is not limited to, a general purpose computer, or computing chip in a mobile device such as, but not limited to, a cellular phone or other hand-held device. The program storage device, 14, may for instance be, but is not limited to, a memory chip, a memory disk or other suitable storage device. The program storage device, 14, may be housed separately from the machine capable of executing instructions, 12, or may be an integral part thereof. The program storage device, 14, may contain instructions in a tangible form that may be read by the machine capable of executing instructions, 12, and case it to perform a variety of actions. These actions may include, but are not limited to, the ability to accept offers to buy an item at a particular, or sale, price, the ability to associate the offer to buy with a discount that may be one of several possible discounts, and to store that offer to buy and the associated discount. This storage may, for instance, take place in the data storage module, 18. The program storage device, 14, may be directed by the tangible instructions stored in the program storage device, 14, to monitor the number of offers for sale accumulated, and when that number reaches a predetermined target value, to close the sale by confirming acceptance of all offers to buy and may also confirm all the associated discounts.

The display devices, 16 may be a part of the machine capable of executing instructions, 12 or may be connected to it by various methods including, but not limited to, wires, wirelessly or over the internet. The display devices, 16 may for instance be part of, but is not limited to, a computer, a telephone, a mobile telephone, a handheld, wireless device or a television. The display devices, 16 may for instance, serve to display the offer for scale, display the state of the sale or be used to communicate offers to buy back to the machine capable of executing instructions, 12, or some combination thereof.

FIG. 2 shows a flow chart having steps representative of one embodiment of the variable discount sales device, 10, of the present invention.

In step 20 computer readable program code in a computer usable medium may cause a computer to accept an offer to buy an item at a sale price.

In step 22 computer readable program code in the computer usable medium may cause the computer to associate the offer to buy with one of two or more different discounts to the sale price. In one preferred embodiments, one of the discounts is for 100% of the sale price. In a further preferred embodiment, the associating between the offer to buy and the discount may be performed randomly, or it may be performed randomly but within a predetermined range of ratios of a desired final distribution of discounts. The association between an offer to buy and a particular discount may also be made by a randomized association to a predetermined matrix of discounts, or by assignment to a next available position in a matrix that may have been randomly determined, or some combination thereof.

In step 24 computer readable program code in a computer usable medium causes the computer to store details of the offer to buy and the associated discount.

In step 26 computer readable program code in a computer usable medium may cause the computer to check if the accumulated number of offers to buy has reached a predetermined, required number. If the number of offers to buy has not reached the required number, the computer readable program code in a computer usable medium may cause the computer to loop back to step 20 to accept a further offer to buy an item at a sale price.

If the number of offers to buy has reached the required number, the computer readable program code in a computer usable medium causes the computer to go to step 28 and confirm all the sales to the entity that made the offers to buy, and also to confirm all the discounts associated with all the offers to buy. In a further preferred embodiment, the confirmation of the associated discounts may be delayed in time with respect to the confirmation of the offer to buy. This delay in confirmation may for instance be, but is not limited to, to wait for receipt of a predetermined, suitable feedback from an issuer of the offer to buy, or their agent, or some third party, or some combination thereof. The feedback may for instance be, but is not limited to, confirmation that the item has arrived, that the item was in a sound condition, that payment has arrived, or some combination thereof.

### EXAMPLES

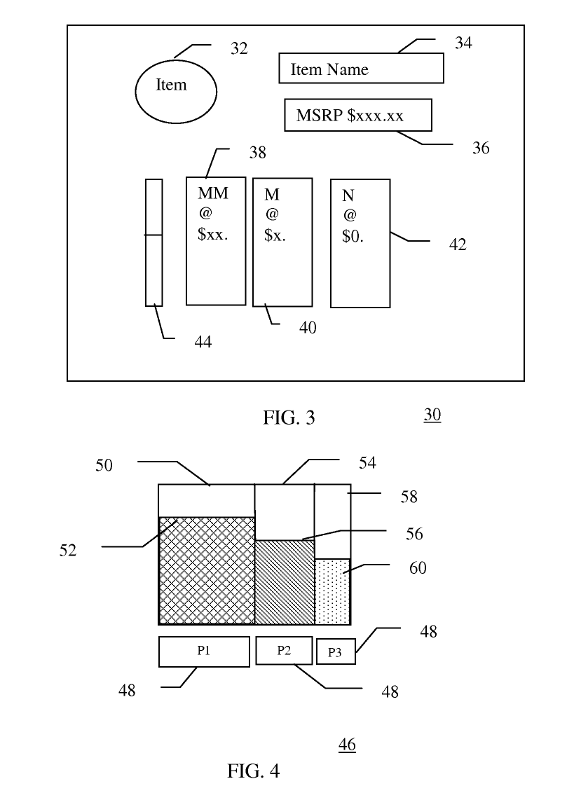

FIG. 3 shows a schematic example of a screen layout 30 for displaying information to a potential buyer in a representative embodiment of the present invention variable discount sales device, 10. The screen layout 30 may for instance be, but is not limited to, a web-page, or a custom screen, displayed on a computer, a mobile device, a television or a mobile telephone screen. The screen layout 30 may include an image of the item for sale 32, a description of the item for sale 34, a manufactures suggested retail price (MSRP) 36, a first matrix column 38, a second matrix column 40, a third matrix column 42 and a fuel gauge 44. The first matrix column 38 shows a number (MM) of items available for sale at a given price (xx) that may be at a discount to the manufactures suggested retail price 36. The second matrix column 40 shows another number (M) of items available for sale at a second price (x) that may have a larger discount with respect to the manufactures suggested retail price 36. The third matrix column 42 shows a third quantity (N) of items available at a third price that may be at 100% discount to the manufactures suggested retail price 36, i.e., in a preferred embodiment, a percentage of the items may be distributed for free. When an offer to buy is made, the variable discount sales device, 10, may randomly assign a discount to the potential buyer. This discount may only be realized when all the items have an offer for sale, i.e., when the fuel gauge 44 reaches 100%.

The variable discount sales device, 10, can be made economically viable because of a number of factors, including, but not limited to, cutting out the middleman, and using direct shipping from manufacturer to customer, rather than shipping from the manufacturer to the middleman, then from the middleman to the customer.

TABLE 1

| Costs | | | | |
|---|---|---|---|---|
| MSPR | $79.00 | | Wholesale price | $31.88 |
| Internet discount | $59.99 | | Shipping direct to | $5.00 |
| Price | | | customer | |
| Lowest price found | $59.99 | | Service provider (10%) | $3.69 |
| | | | Credit card fees (6%) | $2.43 |
| | | | Total cost per item | $43.00 |
| | | | Cost of 1000 items | $43,000.00 |
| When the sale ends | | | | |
| | | Save | | |
| 700 people get item | $50.00 | 9.99 (18%) | Revenue | $35,000.00 |
| for | | | | |
| 200 people get item | $40.00 | 19.00 (33%) | Revenue | $8,000.00 |
| for | | | | |
| 100 people get item | $0.00 | 59.99 (100%) | | $0.00 |
| for | | | | |
| | | | Total Revenue | $43,000.00 |

Table 1 shows an example of how a matrix sale using the variable discount sales device, 10, may be made economically viable. In the example of table 1, all expenses may be covered, including a 10% fee to the service provider, a cost of shipping to the customer and credit card fees. When the sale is complete, all the buyers will have bought at a discount price with respect to the lowest price found. 70% of the buyers will buy the item at a discount of approximately 18%, 20% get a discount of approximately 33% and 10% get the item free of charge—without even paying shipping costs. One of ordinary skill will realize that both the expenses to be considered and the numbers and ratios in table 1 are merely exemplary, and with judicious selection, such a matrix selling system may work—in the sense that everyone who buys, gets a discount over the manufacture's suggested retail price 36—for a wide variety of prices, discount levels, and discount splits.

### Example 1

FIG. 4 shows example 1, a schematic matrix indicating a display of the state of an open matrix, variable discount sales device 46. In this display of the state of an open matrix, variable discount sales device 46, the fuel gauge 44 and the matrix columns have been combined. The display of the state of an open matrix, variable discount sales device 46 includes price indicators 48, a first matrix column 50, a first fuel gauge 52, a second matrix column 54, a second fuel gauge 56, a third matrix column 58 and a third fuel gauge 60. In this example of a matrix display, the width of the first matrix column 50 indicates the number, or percentage, of items available for price P1, while the height of the first fuel gauge 52 shows the number, or percentage, of the offers to buy that currently have the discount implied by price P1 associated with them. Similarly the width of the second matrix column 54 indicates the number, or percentage, of items available for price P2, while the height of the second fuel gauge 56 shows the number, or percentage, of the offers to buy that currently have the discount implied by price P2 associated with them. And the width of the third matrix column 58 indicates the number, or percentage, of items available for price P3, while the height of the third fuel gauge 60 shows the number, or percentage, of the offers to buy currently have the discount implied by price P3 associated with them, and in a preferred embodiment may be completely free to the buyer.

The matrix sale ends when all the fuel gauges reach 100%, i.e., when all the items have an offer to buy associated with them.

### Example 2

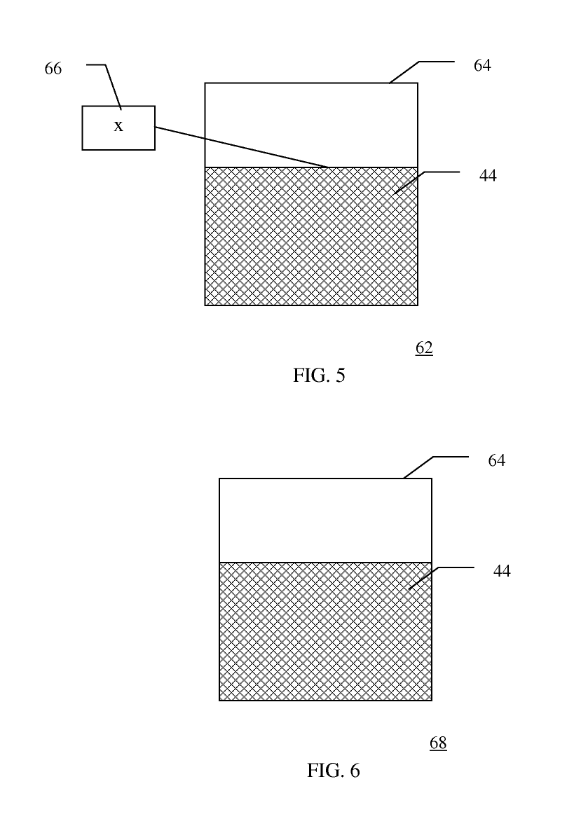

Example 2 is illustrated in, for instance, FIG. 5 that shows a schematic matrix displaying a state of a hidden matrix variable discount sales device 62. The hidden matrix variable discount sales device 62 has only one matrix column 64, one fuel gauge 44 and a display of the buyers price 66. The hidden matrix variable discount sales device 62 may show a buyer their discounted price but may keep that price hidden from all other buyers or potential buyers. Similarly, other buyers prices may be hidden from the current buyer The fuel gauge 44 may show some graphic, such as, but not limited to, dots growing in real time representing the % of available items that currently have offers to buy. In this version of a matrix sale, new buyers should not be discouraged by seeing a lack of available discount opportunities and the incentive to participate may increase as the number of items available diminishes. This arrangement has the advantage of also allowing for a wide price and discount range. This arrangement must sell out before the sale can be ended.

### Example 3

Example 3 is illustrated in, for instance, FIG. 6 that shows a schematic matrix displaying a state of a completely hidden matrix variable discount sales device 68.

A completely hidden matrix variable discount sales device 68 is a variation on a hidden matrix variable discount sales device 62 that hides everything, including the display of the buyers price 66. A buyer may pay for a spot and then wait for the “matrix to pop”, i.e. wait for each of the total number of items available to have an offer for sale. When the matrix pops, the fuel gauge 44 reaches the top of the matrix column 64. At that time the prices may be displayed for everyone to see. Rebates may be automatic and may be dispensed instantly, or their may be a delay, pending receipt of feedback relating to payments made, the arrival of items or the state of the goods or some combination thereof.

This version of a matrix sale should create significant suspense and may be useful for high demand or large quantity sales.

### Example 4

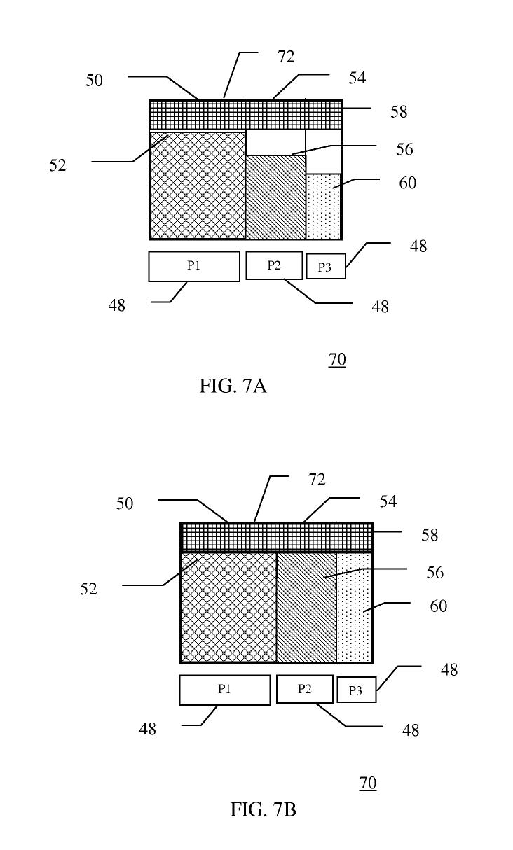

Example 4 is illustrated in, for instance, FIGS. 7A and 7B that show a schematic matrix displaying an 80% open matrix variable discount sales device 70 at a two stages of a sale. The 80% open matrix variable discount sales device 70 is designed so that it can end when it is 80% full or at some other designated number or range of numbers. A blanking out bar 72 covers the top end of a display of the state of an open matrix, variable discount sales device 46. This variant creates an incentive to buy immediately as it may be difficult to gauge when the sale will end as that end may occur at any time from when the fuel gauges all reach the lowest point of the blanking out bar 72. Typically a blanking out bar 72 of a 80% open matrix variable discount sales device 70 will cover up from 80% to 100%, so the sale could stop when ever all the fuel gauges are within that range. Alternately, the blanking out bar 72 could cover up the fuel gauge starting any where. Whether the blanking out bar 72 begins at, for instance, 10%, 20%, 30%, 40%, 50%, 60%, 70%, 80% or 90% may depend on factors such as, but not limited to, the volume of items, the cost of the items or the desired speed of disposal of the items, or some combination thereof.

### Example 5

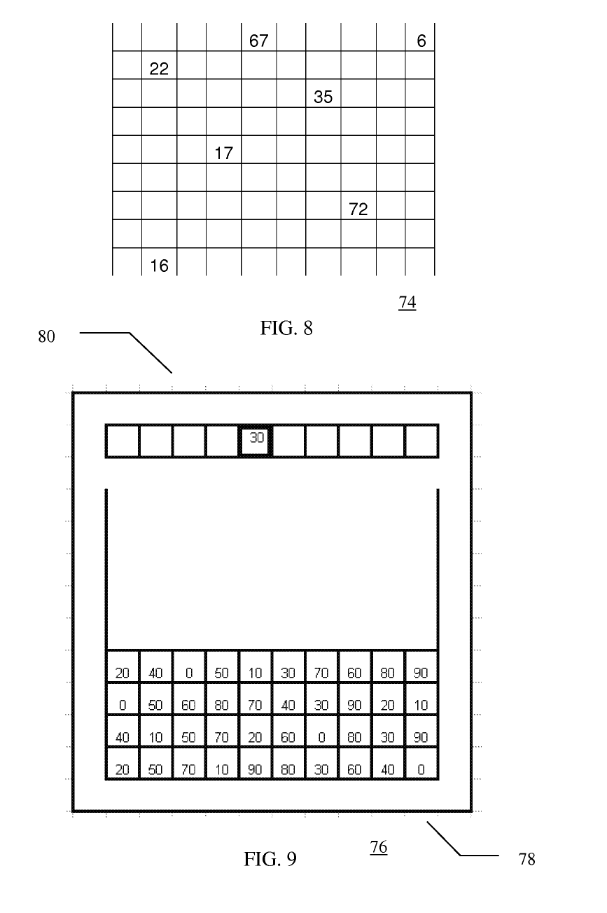

Example 5 is illustrated in, for instance, FIG. 8 that shows a schematic matrix displaying a state of a second chance matrix variable discount sales device 74. A state of a second chance matrix variable discount sales device 74 allows the buyer to discard the first price in exchange for a second price. In a preferred embodiment the second chance number must be kept, though further exchanges may be possible in variations of this version. In one embodiment, the buyer may reserve their second chance option and exercise it at any time before the sale ends. This version allows for an unlimited number of pricing levels.

### Example 6

Example 6 is illustrated in, for instance, FIG. 9 that shows a schematic matrix displaying a state of a split top matrix variable discount sales device 76. The split top matrix variable discount sales device 76 has a top bar 80 and a main matrix 78. When a matrix is populated by chance it may end up lopsided with mostly the cheaper prices taken first. This may, for instance, be true for the state of a second chance matrix variable discount sales device 74 described above.

To avoid this tendency the split top matrix variable discount sales device 76 separates out the top row of the main matrix 78 and displays it separately at a top bar 80, and effectively treats the top bar 80 as a sub-matrix. So instead of having a main matrix 78 with a quantity of, for instance, 100 items, it may be considered as 10 sub-matrixes, each having 10 items. One of ordinary skill will appreciate that these numbers are illustrative only and that a wide variety of specific variations are possible. As the split top matrix variable discount sales device 76 checks and balances each top bar 80 or sub-matrix, the statistical variation may be more limited. The split top matrix variable discount sales device 76 may also allow the sale to end before it is sold out. This may be done fairly without changing any odds as long as the sale ends when a complete bar is full, i.e., it has just bar sold out.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present invention.

### INDUSTRIAL APPLICABILITY

In the field of retail distribution there is significant interest in improved distribution chains such as those facilitated by the present invention. The variable discount sales device, 10, of this invention, would be of considerable utility as, for instance, the liquidation by a manufacturer or wholesaler of excess inventory. The variable discount sales device, 10, of this invention, would also be of considerable utility as, for instance, a means to enable manufacturers to sell directly to the public or small firms

1. A program storage device readable by a machine, tangibly embodying a program of instructions executable by the machine to perform method steps for:
a) accepting an offer to buy an item at a sale price;
b) associating said offer to buy with one of a plurality of discounts to said sale price;
c) storing said offer to buy and said associated discount;
d) repeating steps a-c until a predetermined quantity of offers to buy is accumulated; and
e) upon accumulating said predetermined quantity of offers to buy, confirming all of said offers to buy and all of said associated discounts.

2. The program storage device claim 1 wherein said plurality of discounts to said sale price includes one discount level of 100%.

3. The program storage device of claim 2 wherein said associating said offer to buy with one of said plurality of discounts is performed randomly within a predetermined range of ratios of desired, final discounts.

4. The program storage device of claim 2 wherein said associating said offer to buy with one of said plurality of discounts is performed by random assignment to a predetermined matrix of discounts.

5. The program storage device of claim 5 wherein said program of instructions is further capable of execution by said machine for generating said predetermined matrix of discounts.

6. The program storage device of claim 1 wherein said confirming all of said associated discounts is delayed with respect to said step of confirming all of said offers to buy until receipt of a predetermined, suitable feedback from an issuer of said offer to buy.

7. An article of manufacture comprising:
a computer usable medium having computer readable program code means embodied therein for causing a computer to:
a) accept an offer to buy an item at a sale price;
b) associate said offer to buy with one of a plurality of discounts to said sale price;
c) store said offer to buy and said associated discount;
d) repeat steps a-c until a predetermined quantity of offers to buy is accumulated; and
e) upon accumulating said predetermined quantity of offers to buy, confirming all of said offers to buy and confirming all of said associated discounts.

8. The article of manufacture of claim 7 wherein said plurality of discounts to said sale price includes one discount level of 100%.

9. The article of manufacture of claim 8 wherein said associating said offer to buy with one of said plurality of discounts is performed randomly within a predetermined range of ratios of desired, final discounts.

10. The article of manufacture of claim 8 wherein said associating said offer to buy with one of said plurality of discounts is performed by random assignment to a predetermined matrix of discounts.

11. The article of manufacture of claim 10 wherein said computer readable program code means is further capable of generating said predetermined matrix of discounts.

12. The article of manufacture of claim 7 wherein said confirming all of said associated discounts is delayed with respect to said step of confirming all of said offers to buy until receipt of a predetermined, suitable feedback from an issuer of said offer to buy.
